(19) United States
(12) Patent Application Publication
(10) Pub. No.: US 2008/0256019 A1
(43) Pub. Date: Oct. 16, 2008

(54) METHOD AND SYSTEM FOR FAST ACCESS TO METAINFORMATION ABOUT POSSIBLE FILES OR OTHER IDENTIFIABLE OBJECTS

(75) Inventors: Bowen Alpern, Peekskill, NY (US); Joshua S. Auerbach, Ridgefield, CT (US); Vasanth Bala, Rye, NY (US); Thomas V. Frauenhofer, Stony Point, NY (US); Todd W. Mummert, Danbury, CT (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/735,708

(22) Filed: Apr. 16, 2007

(51) Int. Cl. G06F 17/30

(52) U.S. Cl. 707/1; 707/E17.001

(57) ABSTRACT

A method and computer system for determining an existence of a file and, possibly, information related to the file are provided. The method and system include providing a file name, generating a file designator from the file name, and generating a hash value from the file name. The hash value is used to index a cache containing other file designators that meet a certain criterion, and if no entry is found in the cache, an operating system call is performed. If an entry is found in the cache, the entry of the cache is compared with the generated file designator. If the entry and the generated file designator are not the same, an operating system call is performed. If the entry and the generated file designator are the same, this indicates that the criterion is satisfied.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

Exemplary embodiments relate to determining information about files, and more particularly to determining whether a file exists and the condition of the file.

Computer systems continue to expand and to have numerous files in a file system. Determining whether a particular file exists in a file system and/or determining whether a file has any desirable collection of attributes (e.g., is it readable and was it recently modified) can be an expensive operation (e.g., perhaps ½ a millisecond system call on a modern Windows XP™ system).

In computing, an operating system call (or system call) is the mechanism used by an application program to request service from the operating system. In particular, a system call can be used to determine whether a particular file exists, and if it exists, whether it is readable or writable, whether it can be executed, when it was last modified, etc. Such information about a file is called metainformation. Application programs are a series of instructions, which manipulate data in memory). There can be many programs running on the same machine simultaneously. In addition to bare computing, the programs usually need to communicate with the real world, which consists of hardware, for observing and controlling it.

It is desirable to have fast and inexpensive techniques for determining metainformation for files.

### SUMMARY

In accordance with an exemplary embodiment, a computer system is provided that includes a cache with designators for files that satisfy a certain criterion. One of the designators uniquely corresponds to one of the files. The computer system also includes a processor that is configured to generate a hash value and another designator from a respective file name of the files. The hash value is an index for the cache to retrieve one of the designators that corresponds to one of the files. The other designator uniquely corresponds to one of the files. The designator from the cache is compared to the other designator generated by the processor to determine whether the designator and the other designator are the same. If the designator and the other designator are the same, the criterion is met. If there is no designator from the cache, or if the designator and the other designator are not the same, it is inconclusive as to whether or not the criterion is met.

In accordance with another exemplary embodiment, a method for determining an existence of a file and possibly metainformation about the file is provided. The method includes providing a file name, generating a file designator from the file name, and generating a hash value from the file name. The hash value is used to index a cache containing other file designators that meet a certain criterion, and if no entry is found in the cache, an operating system call is performed. If an entry is found in the cache, the entry of the cache is compared with the generated file designator. If the entry and the generated file designator are not the same, the results are inconclusive, and an operating system call is performed. If the entry and the generated file designator are the same, this indicates that the criterion is satisfied.

Additional features and advantages are realized through the techniques of the present disclosure. For a better understanding of the advantages and features disclosed herein, refer to the description and to the drawings. dr

### BRIEF DESCRIPTION OF THE DRAWINGS

The subject matter which is regarded as the invention is particularly pointed out and distinctly claimed in the claims at the conclusion of the specification. The foregoing and other features and advantages are apparent from the following detailed description taken in conjunction with accompanying drawings in which:

FIG. 1 illustrates an exemplary embodiment of a computer system; and

FIG. 2 illustrates an exemplary embodiment of an operation that determines the existence of a file and/or information related to the file.

The detailed description explains the exemplary embodiments, together with advantages and features, by way of example with reference to the drawings.

### DETAILED DESCRIPTION

Exemplary embodiments may use hashing and caching techniques to determine the existence of files and/or file information (e.g., metainformation) related to files in a file system or in a specified subset of a file system by using, for example, a table lookup.

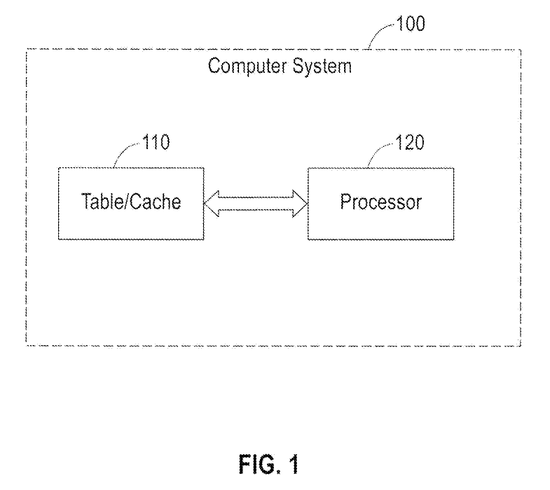

FIG. 1 illustrates an exemplary embodiment of a computer system 110 that may be used to determine whether a file in a file system exists or exists with a particular property (e.g., the file is writable, or the file was modified after a particular date). The computer system 100 includes a table 110 and a processor 120. The table (or cache) 110 maintains designators for files that satisfy a given criterion (e.g., existence). A designator must uniquely identify a file and must be computable from the file's name, for example, the absolute path. The absolute path, also referred to as the full path, is a path that contains the root directory and all other sub directories required to access the file. To determine if a given file name (or path) satisfies the criterion, the file designator and a hash value are computed from the name (e.g., by processor 120), the hash value is used as an index into the table 110, and the corresponding entry is examined. If the entry is the file designator for the file name, the file satisfies the criterion. Thus, the operation may indicate that a particular file exists, or that it exists with a particular property.

If the entry is empty, or if another file designator is in the entry, the query is inconclusion. In the case of an inconclusive query, an operating system call may be performed to obtain a definitive rehashing. Moreover, one with ordinary skill in the art will understand that any conventional rehashing, hash bucketing, or cache associativity scheme could also be used to provide an answer. The table may, or may not, be altered for future reference to reflect the definitive answer when the file is found to satisfy the criterion.

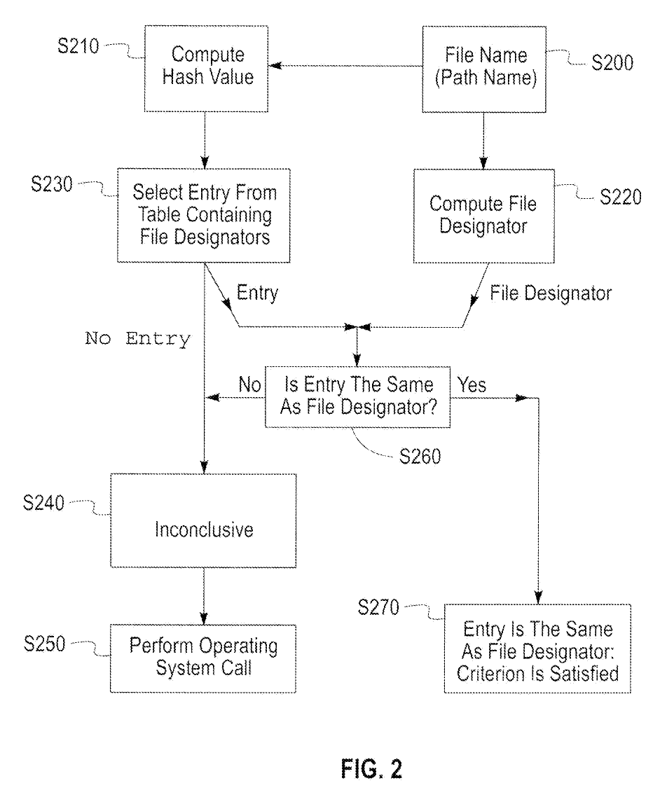

FIG. 2 illustrates an exemplary embodiment of an operation that determines the existence of a file. In determining whether a file exists, a file name or path name is used (S200). The file name is used to compute a file designator (S220) and to compute a hash value (S210). The hash value is used to index a table (or a cache) containing file designators on the computer system (S230). If no entry is found, the result is inconclusive (S240), and an operating system call is performed (S250).

If an entry is found in S230, the entry is compared with the file designator computed in S220 (S260). If the entry and the file designator are not the same, the result is inconclusive (S240), and an operating system call is performed (S250). If the entry and the file designator are the same, the criterion is satisfied for the file (S270).

Further, if an operating system call is performed, and the criterion is satisfied, the table (cache) may be updated accordingly.

One skilled in the art will understand that the table, containing file designators, may be augmented with aggregate metainformation about the designated files.

The present disclosure may be particularly applicable to a system like the Progressive Deployment System (PDS) that uses a portion of the file system to cache chunks of data (e.g., shards in PDS) in files that must be obtained remotely if they are not available locally. PDS may be divided into four major subsystems: preparation, delivery, execution, and service. Additional information regarding PDS is disclosed in U.S. patent application Ser. No.: 2006/0047974 A1, herein incorporated by reference.

Furthermore, the exemplary embodiments are particularly efficient to implement in systems like PDS in which the designator for a file is an abbreviation of the file name. PDS shards may be named by a cryptographic hash of their contents (or in some other fashion) with “0.0” appended. These names may be presumed to be unique and may be used as designators. They may be presumed to be random (or otherwise uniformly distributed), so a fixed collection of bits from a designator may be used at the required hash.

In exemplary embodiments, the file descriptor may be a 48-bit hash of the full path name of the file, and the hash may be some 16-bit subset of the descriptor. One skilled in the art will understand that only the remaining 32 bits of the descriptor need to be stored in the table. Also, one skilled in the art will understand that the descriptor and hash could be longer or shorter than 48 and 16 bits, respectively.

One skilled in the art will recognize that what has been described with reference to “files” in a “file system” applies mutatis mutandis to “keys” in a “Windows Registry”, “entries” in a zip or Jar “archive”, etc.

The capabilities described in the present disclosure may be implemented in software, firmware, hardware, or some combination thereof.

Further, one or more features of the present disclosure may be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or sold separately.

Additionally, at least one program storage device readable by a machine, tangibly embodying at least one program of instructions executable by the machine to perform the capabilities of the present disclosure may be provided.

The flow diagrams depicted herein are just examples. There may be many variations to these diagrams or the steps (or operations) described therein without departing from the spirit of the present disclosure. For instance, the steps may be performed in a differing order, or steps may be added, deleted, or modified. All of these variations are considered a part of the claimed invention.

While exemplary embodiments have been described, it will be understood that those skilled in the art, both now and in the future, may make various improvements and enhancements which fall within the scope of the claims which follow. These claims should be construed to maintain the proper protection for the invention first described.

What is claimed is:

1. A computer system, comprising:
a cache comprising designators for a plurality of files satisfying a certain criterion, one of the designators uniquely corresponding to one of the plurality of files; and
a processor configured to generate a hash value and another designator from a respective file name of the plurality of files, the hash value being an index for the cache to retrieve one of the designators that corresponds to one of the plurality of files, and the other designator uniquely corresponds to one of the plurality of files;
wherein the designator from the cache is compared to the other designator generated by the processor to determine whether the designator and the other designator are the same;
wherein if the designator and the other designator are the same, the criterion is met; and
wherein if there is no designator from the cache, or if the designator and the other designator are not the same, it may be inconclusive as to whether or not the criterion is met.

2. The computer system of claim 1, wherein the file name is the absolute path of one file of the plurality of files; and
wherein the criterion indicates the existence of one file of the plurality of files and may indicate metainformation related to one file of the plurality of files.

3. The computer system of claim 1, wherein the computer system operates in a Progressive Deployment System (PDS) environment.

4. The computer system of claim 1, wherein, if the criterion for one file of the plurality of files is met, various metainformation about the file may be obtained from the cache.

5. A method for determining whether a file name corresponds to a file satisfying a certain criterion, the method comprising:
providing a file name;
generating a file designator from the file name;
generating a hash value from the file name;
indexing, via the hash value, a cache containing other file designators that meet a certain criterion;
if no entry is found in the cache, performing an operating system call;
if an entry is found in the cache, comparing the entry of the cache with the generated file designator;
if the entry and the generated file designator are not the same, performing an operating system call; and
if the entry and the generated file designator are the same, indicating that the criterion is satisfied.

6. The method of claim 5, wherein:
the operations are performed in a Progressive Deployment System (PDS) environment;
the file name is the absolute path name; and
the criterion provides at least one of an existence of a file, whether the file is writable, whether the file is readable, whether the file may be executed, and whether the file has been modified since a particular time, and binary metainformation about the file.
